(19) United States
(12) Patent Application Publication
(10) Pub. No.: US 2008/0305946 A1
(43) Pub. Date: Dec. 11, 2008

(54) Platinum Alloy Carbon-Supported Catalysts

(75) Inventors: Lixin Cao, Princeton, NJ (US); Yu-Min Tsou, Princeton, NJ (US); Emory De Castro, Nahant, MA (US)

Correspondence Address: CONNOLLY BOVE LODGE & HUTZ, LLP, P O BOX 2207, WILMINGTON, DE, 19899, US

(73) Assignee: PEMEAS GMBH, Frankfurt (DE)

(21) Appl. No.: 11/720,384

(22) PCT Filed: Nov. 28, 2005
(86) PCT No.: PCT/EP2005/012676

§ 371 Date: Mar. 24, 2008

Related U.S. Application Data
(60) Provisional application No. 60/631,384, filed on Nov. 29, 2004.

(51) Int. Cl. B01J 21/18; B01J 23/42

(52) U.S. Cl. 502/185

(57) ABSTRACT

The instant invention relates to a platinum alloy supported electrocatalyst for gas diffusion electrode and/or in catalyst-coated membrane.

### FIELD OF THE INVENTION

A catalyst, in particular to a platinum alloy carbon-supported electrocatalyst suitable for incorporation in a gas diffusion electrode or in a catalyst-coated membrane structure.

### BACKGROUND OF THE INVENTION

Carbon-supported platinum is a well-known catalyst for incorporation into gas-diffusion electrode and catalyst-coated membrane structures, for instance in fuel cell, electrolysis and sensor applications. In some cases, it is desirable to alloy platinum with other transition metals for different purposes; the case of platinum alloys with other noble metals, such as ruthenium, is for instance, well-known in the field of carbon monoxide-tolerant anode catalysts and of gas diffusion anodes for direct methanol fuel cells (or other direct oxidation fuel cells). Carbon-supported platinum alloys with non-noble transition metals are also known to be useful in the field of fuel cells, especially for gas diffusion cathodes. Platinum alloys with nickel, chromium or cobalt usually display a superior activity towards oxygen reduction. These alloys can be even more useful for direct oxidation fuel cell cathodes since, in addition to their higher activity, they are also less easily poisoned by alcohol fuels which normally contaminate the cathodic compartments of these cells to an important extent as they can partially diffuse across the semipermeable membranes employed as the separators.

Carbon-supported platinum alloy catalysts of this type are, for instance, disclosed in U.S. Pat. No. 5,068,161, to Johnson Matthey PLC which describes the preparation of binary and ternary platinum alloys, for instance, comprising nickel, chromium, cobalt or manganese, by boiling chloroplatinic acid and a metal salt in the presence of bicarbonate and of a carbon support. The mixed oxides of platinum and of the relevant co-metals hence precipitate on the carbon support and are subsequently reduced, first by adding formaldehyde to the solution, then with a thermal treatment at 930° C. in nitrogen. It can be assumed therefore that platinum and the co-metals are reduced in two distinct steps: Pt reduction is most likely completed in the aqueous phase, while other oxides, such as nickel or chromium oxide, would be converted to metal during the subsequent thermal treatment, probably above 900° C.

This explains why the degree of alloying is rather low, as evidenced by XRD scans showing that segregation occurs to an important extent, with the formation of large domains of individual elements and of a limited alloyed phase. Besides losing some of the desired electrochemical characteristics belonging to the proper platinum catalysts, this lack of structure uniformity also results in an unsatisfactory average particle size and distribution thereof. Moreover, the use of chloroplatinic acid introduces chloride ions into the system, which are difficult to completely remove and which can act as a poison for the catalyst and lower its activity.

An alternative way for obtaining a platinum alloy catalyst is disclosed in U.S. Pat. No. 5,876,867 to Chemcat Corp., wherein a carbon-supported platinum catalyst is treated with a soluble salt of the second metal (for instance cobalt nitrate) in an aqueous solution, dried and heated at high temperature to induce alloy formation. Also, in this case, however, the degree of alloying is typically insufficient. Besides the poisoning effect, the residual chloride ions which may be present on the initial carbon-supported platinum catalyst (which is again typically produced through the chloroplatinic route) can somehow hinder the formation of a homogeneous alloy between Pt and the second metal.

### OBJECTS OF THE INVENTION

It is an object of the invention to provide a carbon-supported platinum alloy catalyst characterized by a high degree of alloying and by a small and uniform particle size.

It is another object of the invention to provide a gas-diffusion electrode for use on electrochemical applications incorporating a carbon-supported platinum alloy catalyst characterized by a high degree of alloying and by a small and uniform particle size on an electrically conducting web.

It is a further object of the invention to provide a catalyst-coated membrane for use on electrochemical applications incorporating a carbon-supported platinum alloy catalyst characterized by a high degree of alloying and by a small and uniform particle size on an ion-exchange membrane.

It is also an object of the invention to provide a method for the formation of a carbon-supported platinum alloy catalyst characterized by a high degree of alloying and by a small and uniform particle size.

These and other objects and advantages of the invention will become obvious from the following detailed description.

### THE INVENTION

Under a first aspect, the invention consists of a carbon-supported platinum alloy catalyst obtained by simultaneous chemical reduction of platinum dioxide and of at least one transition metal hydrous oxide MO_{x-y}H₂O on a carbon support, wherein M is any transition metal, more advantageously selected between nickel, cobalt, chromium, vanadium and iron. In a preferred embodiment, platinum dioxide is precipitated from dihydrogen hexahydroxyplatinate, H₂Pt(OH)₆, also known as platinic acid, and the transition metal hydrous oxide is obtained by conversion of a soluble transition metal salt, preferably a nitrate. More than one transition metal hydrous oxide can be simultaneously reduced with the platinum dioxide, for example, to form a carbon-supported ternary or quaternary alloy.

The advantageous formation of carbon-supported platinum catalyst from in situ-formed PtO₂ colloids has been described in co-pending Patent Application Ser. No. 60/561,207, filed Sep. 4, 2004, which is incorporated herein as reference in its entirety. The thermal kinetic control on PtO₂ colloid formation allows the simultaneous precipitation of a large number of particles, which are quickly absorbed on the carbon support before they can grow beyond a certain size. In the case of the present invention, PtO₂ and hydrous transition metal oxide MO_{x-y}H₂O are formed in a single solution mixture without separation. After the formation of PtO₂ according to the teaching of the cited copending application, a metal salt solution, preferably being metal nitrate solution, is added. A chemical agent is then added to induce the formation of hydrous metal oxide, which absorbs on the PtO₂ impregnated-carbon support. The co-absorbed PtO₂ and hydrous metal oxide MO_{x-y}H₂O are then collected by filtration, dried and co-reduced in hydrogen at high temperature, preferably above 300° C. A subsequent high temperature treatment, preferably above 600° C., is then carried out only for annealing and completing the alloy formation while any carbonaceous particle can be used as the carbon support, carbon black of high surface area (at least 50 m²/g) is nevertheless preferred.

The Pt alloy thus formed is homogeneous at atomic scale, presenting a very controlled particle size and a minimum contamination from foreign ions. This catalyst can be used in a wide range of electrochemical processes, for instance, in gas diffusion cathodes and anodes for fuel cells, including direct oxidation fuel cells.

Under a second aspect, the invention consists of a gas-diffusion electrode obtained by incorporating the above-disclosed catalyst in an electrically conductive web, for instance, a carbon woven or non-woven cloth or carbon paper. Under another aspect, the invention consists of a catalyst-coated membrane obtained by incorporating the above-disclosed catalyst on an ion-exchange membrane.

Under yet another aspect, the invention consists of a method for the production of a carbon-supported platinum alloy catalyst, comprising simultaneously reducing in situ-formed platinum dioxide and at least one transition metal hydrous oxide on a carbon support. In a preferred embodiment, in situ formation of platinum dioxide is obtained by converting a dihydrogen hexahydroxyplatinate precursor, optionally pre-adsorbed on a carbon support. Such conversion is preferably carried out by a variation of pH and/or temperature, optionally by controlled addition of an alkali such as caustic soda or of ammonia to the acidic starting solution, for instance, until reaching a pH between 2 and 9, and/or by raising the temperature from room temperature to a final temperature comprised between 30 and 100° C., preferably 70° C.

A high active area carbon black is preferably employed as the carbon support and, in a preferred embodiment, prior to the adsorption of the precursor, the carbon black support is slurried in concentrated nitric acid, so that the resulting slurry can be used to easily dissolve platinic acid. Other preferably non-complexing strong acids can be used instead of nitric acid, such as, for example, HClO₄, H₂SO₄, CF₃COOH, toluenesulfonic acid or trifluoromethane-sulphonic acid. After obtaining the in situ formation of PtO₂, a suitable precursor of at least one transition metal oxide, preferably a soluble salt and even more preferably a nitrate, is added to the solution. The precursor is then converted to the transition metal hydrous oxide, for instance by further addition of alkali. After filtration and drying, the co-absorbed PtO₂ and hydrous metal oxide are reduced to the corresponding metals, preferably by hydrogen at high temperature, above 300° C. In the final step, a high temperature annealing process, at a temperature of 600° C. or higher, is carried out to complete the alloy formation.

### BRIEF DESCRIPTION OF THE FIGURES

FIG. 1 is a group of fuel cell polarization curves relative to a catalyst of the invention and a catalyst of the prior art.

FIGS. 2 and 3 are XRD spectra relative to catalysts of the invention and to the prior art.

In the following examples, there are described several preferred embodiments to illustrate the invention but it should be understood that the invention is not intended to be limited to the specific embodiments.

### EXAMPLE 1

100 g of 30% by weight Pt—Ni catalyst (Pt:Ni 1:1, atomic base) on Vulcan XC-72 carbon black were prepared according to the following procedure:

70 g of Vulcan XC-72 from Cabot Corp./USA were suspended in 2.5 liters of ionized water in a 4 liter beaker. The carbon was finely dispersed by sonicating for 5 minutes and the slurry was then stirred by means of a magnetic stirrer, and 87 ml of concentrated (−69%) HNO₃ were added thereto.

36.03 g of platinic acid, PTA (corresponding to 23.06 g of Pt) were added to 413 ml of 4.0 M HNO₃ in a separate flask. The solution was stirred until complete dissolution of the PTA, with formation of a reddish coloring. This PTA solution was then transferred to the carbon slurry and stirred at ambient temperature for 30 minutes. The beaker was then heated at a rate of 1° C./min up to 70° C., and this temperature was maintained for 1 hour under stirring. The heating was then stopped, and a 15.0 M NaOH solution was added to the slurry at a rate of 10 ml/min, until reaching a pH between 3 and 3.5 (approximately 200 ml of NaOH solution were added). The solution was allowed to cool down to room temperature, still under stirring.

34.37 g of Ni(NO₃)₂₋₆H₂O (20.19% Ni, 6.94 g Ni total) were dissolved in 150 ml of deionized water, and added to the slurry. After 30 minutes, the heating was resumed, raising the temperature to 75° C. at the rate of 1° C./min. The solution was stirred during the whole process, and the pH was controlled at ˜8.5 with further additions of NaOH. After reaching 75° C., heating and stirring were both maintained for 1 hour. Then, the slurry was allowed to cool down to room temperature and filtered. The catalyst cake was washed with 1.5 liter of deionized water, subdivided into 300 ml aliquots, then dried at 125° C. until reaching a moisture content of 2%. The dried cake was ground to 10 mesh granule, and the obtained catalyst was reduced for 30 minutes at 500° C. in a hydrogen steam, then sintered at 850° C. in argon for 1 hour and ball-milled to fine powder.

### EXAMPLE 2

The procedure of Example 1 was modified to obtain 30% by weight Pt:Ni 2:1 catalyst on Vulcan XC-72. For this purpose, the amount of PTA was increased to 40.75 g (26.08 g Pt total), while that of Ni(NO₃)₂₋₆H₂O added to the slurry was decreased to 19.43 g (20.19% Ni, 392 g Ni total).

### EXAMPLE 3

The procedure of Example 1 was modified to obtain 30% by weight Pt:Ni 3:1 catalyst on Vulcan XC-72. For the purpose, the amount of PTA was increased to 42.60 g (27.27 g Pt total) while that of Ni(NO₃)₂₋₆H₂O added to the slurry was decreased to 13.54 g (20.19% Ni, 2.73 g Ni total).

### EXAMPLE 4

The procedure of Example 1 was modified to obtain 30% by weight Pt:Ni 4:1 catalyst on Vulcan XC-72. For this purpose, the amount of PTA was increased to 43.60 g (27.90 g Pt total) while that of Ni(NO₃)₂₋₆H₂O added to the slurry was decreased to 10.39 g (20.19% Ni, 2.10 g Ni total).

### EXAMPLE 5

The procedure of Example 3 was modified to obtain 30% by weight Pt:Co 3:1 catalyst on Vulcan XC-72. For this purpose, nickel nitrate was replaced with a molar equivalent amount of cobalt nitrate.

### EXAMPLE 6

100 g of 30% by weight Pt—Cr catalyst (Pt:Cr 3:1) on Vulcan XC-72 carbon black were prepared according to the following procedure:

70 g of Vulcan XC-72 from Cabot Corp./USA were suspended in 2.5 liters of deionized water in a 4 liter beaker and the carbon was finely dispersed by sonicating for 15 minutes. The slurry was then stirred by means of a magnetic stirrer, and 87 ml of concentrated (˜69%) HNO₃ were added thereto.

43.05 g of platinic acid, PTA (corresponding to 27.55 g of Pt) were added to 413 ml of 4.0 M HNO₃ in a separate flask. The solution was stirred was stirred until complete dissolution of PTA, with formation of a reddish coloring. This PTA solution was then transferred to the carbon slurry and stirred at ambient temperature for 30 minutes. The beaker was then heated at a rate of 1° C./min up to 70° C., and this temperature was maintained for 1 hour under stirring. The heating was then stopped, and concentrated ammonia (˜30%) was added to the slurry at a rate of 10 ml/min, until reaching a pH between 3 and 3.5 (approximately 200 ml of ammonia were added). The solution was allowed to cool down to room temperature, still under stirring.

18.88 g of Cr(NO₃)·9H₂O (12.98% Cr, 2.45 g Cr total) were dissolved in 150 ml of deionized water, and added to the slurry. After 30 minutes the pH of the slurry was adjusted to ˜4.5 with 0.5 M NH₄OH, and after 30 more minutes, the heating was resumed, raising the temperature to 75° C. at the rate of 1° C./min. The solution was stirred during the whole process, and the pH was controlled at ˜5.5 with further additions of ammonia. After reaching 75° C., heating and stirring were both maintained for 1 hour, and then the slurry was allowed to cool to room temperature and filtered. The catalyst cake was washed with 1.5 liters of deionized water, subdivided into 300 ml aliquots, and then dried at 125° C. until reaching a moisture content of 2%. The dried cake was ground to 10 mesh granule, and the obtained catalyst was reduced for 30 minutes at 500° C. in a hydrogen stream, then sintered at 850° C. in argon for 1 hour and ball-milled to fine powder.

### EXAMPLE 7

A gas diffusion electrode was prepared by applying a first layer of Shawinigan Acetylene Black (SAB)/PTFE layer (60/40 wt) from an ink solution on a Textron carbon cloth with a gravure/roller coating machine, and a second layer of Vulcan XC-72/PTFE (60/40 wt). The coated carbon cloth was sintered at 340° C. The sintered gas diffusion layer so obtained was used as a substrate to apply a 2:1 by weight catalyst/ionomer suspension ink, wherein the catalyst was PtCr/C of Example 6, and the fluorocarbon polymer ionomer suspension was prepared from 9% commercial fluorocarbon materials in alcohol. A Pt loading of about 0.4-0.5 mg/cm² was obtained in several coats. A final annealing at 100-130° C. was conducted after the desired platinum loading was reached.

### COMPARATIVE EXAMPLE 1

A gas diffusion electrode was prepared according to the procedure described in Example 7 except the catalyst used was 30% Pt/C prepared with platinic acid, according to the procedure of Example 1 but omitting the addition and subsequent conversion of nickel nitrate.

### EXAMPLE 8

A Membrane-Electrode Assembly (MEA) was made by incorporating the gas diffusion electrode prepared in Example 7 as the cathode and a standard machine-made 30% PT/C gas diffusion electrode as the anode that was impregnated with fluorocarbon polymer ionomer as known in the art and hot-pressed on opposite sides of a commercial membrane according to standard procedure. Another MEA was made with the same procedure but using the gas diffusion electrode of Comparative Example 1 as the cathode. Each MEA was installed in a lab fuel cell, operated at 70° C. and 100% humidification of the reactant gases (air/pure H₂). The pressure was 4 bar absolute on the cathode side and 3.5 bar absolute on the anode side at fixed flow-rates, corresponding to a stoichiometric ratio of 2 for air and 1.5 for hydrogen at 1.2 A/cm².

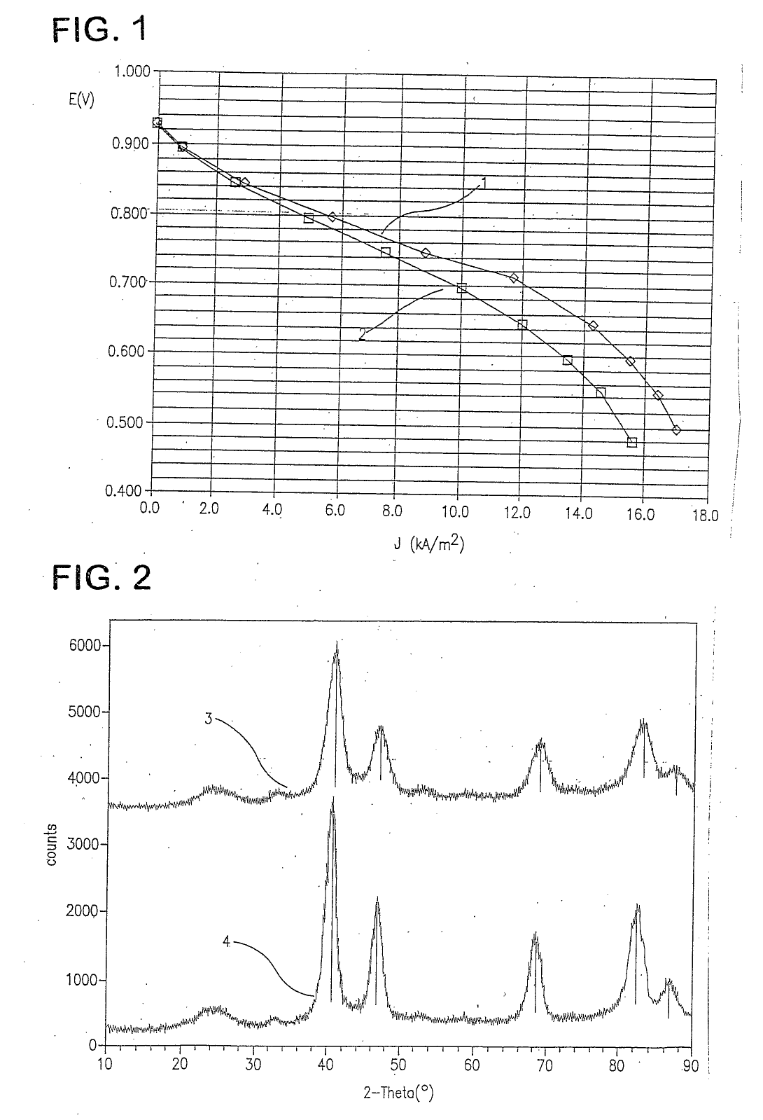

The corresponding polarization curves are reported in FIG. 1, clearly showing that 30% Pt:Cr on carbon (1) is a more active cathode catalyst than the standard 30% Pt on carbon (2).

### EXAMPLE 9

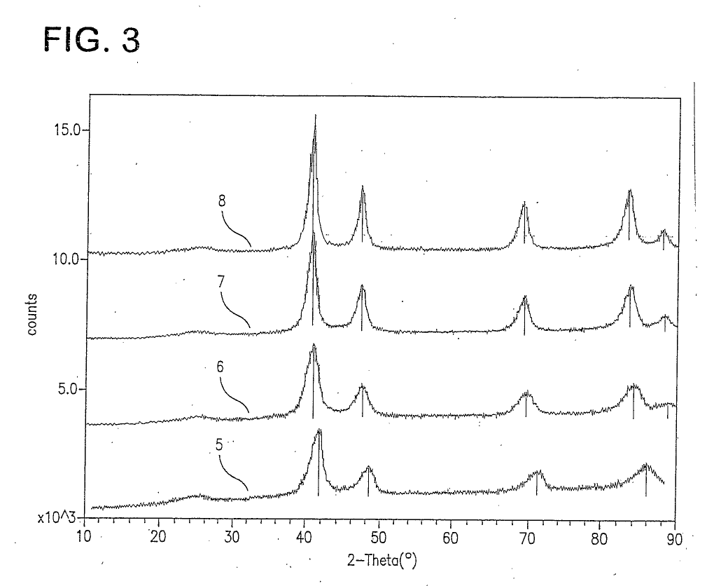

FIG. 2 reports the XRD spectra of the 3:1 PtCr catalyst of Example 6 (3) and of a 3:1 PtCr catalyst prepared in accordance with the teaching of U.S. Pat. No. 5,876,867 (4). The Pt 220 peak (around 2θ=68-69) is at a higher value for the catalyst of Example 6 and this is an indication of a more advanced degree of alloying. Moreover, the “super-lattice peaks” between 2θ=40 and 48 are more pronounced for the catalyst of Example 6. These peaks are associated with good O₂ reduction activity. The catalyst of Example 6 has also a smaller XRD size (37 A) compared to that of the prior art catalyst (53 Å). This indicates that the catalyst of Example 6 has a higher surface area which is also associated with a better performance.

FIG. 3 reports the XRD spectra of the catalysts of Examples 1 (5), 2 (6), 3 (7) and 4 (8) and the patterns are the same as for Pt/C, with a shift in the peak positions. This indicates a very high degree of alloying between Pt and Ni so that Ni metal single phase is not detectable. As the Ni content increases from Pt₄Ni(8) to PtNi(5), each subsequent peak is further away from the corresponding peak for Pt. When more Ni is incorporated into the Pt lattice, the d-spacing becomes smaller. For example, for the Pt {220} peak (2θ=72), the d-spacing for Pt₄Ni, Pt₃Ni, Pt₂Ni and PtNi is 1.3649, 1.3569, 1.3498 and 1.3270, respectively. The d-spacing for 30% Pt/C is 1.3877.

The catalysts may be varied without departing from the spirit or scope of the invention and it is to be understood the invention is intended to be limited only as defined in the appended claims.

1. A carbon-supported platinum alloy catalyst obtainable by simultaneous chemical reduction of in situ-formed platinum dioxide and of at least one transition metal hydrous oxide on a carbon support.

2. The catalyst of claim 1 wherein said carbon support is a carbon black having an active area not less than 50 m²/g.

3. The catalyst of claim 1 wherein said in situ-formed platinum dioxide is obtained by conversion of dihydrogen hexahydroxyplatinate on said carbon support.

4. The catalyst of claim 1 wherein said at least one transition metal hydrous oxide is obtained by conversion of a soluble salt on said carbon support.

5. The catalyst of claim 4 wherein said soluble salt is a nitrate.

6. The catalyst of claim 1 wherein said transition metal is selected from the group consisting of Ni, Cr, Co, V and Fe.

7. The catalyst of claim 1 wherein said chemical reduction is carried out with hydrogen gas at a temperature of at least 300° C.

8. The catalyst of claim 1 further subjected to an annealing treatment in a controlled atmosphere at a temperature of at least 600° C.

9. The catalyst of claim 8 wherein said controlled atmosphere is an inert argon or nitrogen atmosphere.

10. A gas-diffusion electrode comprising an electrically conductive web, and a catalyst of claim 1 incorporated therein.

11. A membrane-electrode assembly comprising an ion-exchange membrane and at least one gas diffusion electrode of claim 10 incorporated therein.

12. A method for the production of a carbon-supported platinum alloy catalyst comprising simultaneously reducing in situ-formed platinum dioxide and at least one transition metal hydrous oxide on a carbon support.

13. The method of claim 12 wherein said in situ formation of platinum dioxide is obtained by converting a dihydrogen hexahydroxyplatinate precursor on said carbon support by a variation of pH and/or temperature.

14. The method of claim 12 wherein said at least one transition metal hydrous oxide is obtained by converting a soluble salt on said platinum dioxide-containing carbon support by a variation of pH and/or temperature.

15. The method of claim 13 wherein said variations of pH are obtained by the addition of alkali, optionally caustic soda, or ammonia.

16. The method of claim 15 wherein said addition of alkali or ammonia is effected up to a pH between 2 and 9.

17. The method of claim 13 wherein said variation of temperature consists of bringing said aqueous solution from room temperature to a final temperature of 30 to 100° C.

18. The method of claim 12 wherein said carbon support is a carbon black having an active area not less than 50 m²/g.

19. The method of claim 18 wherein said carbon black is slurried in a strong acid.

20. The method of claim 12 wherein said transition metal is selected from the group consisting of Ni, Cr, Co, V and Fe.

21. The method of claim 14 wherein said transition metal soluble salt is a nitrate.

22. The method of claim 12 wherein said chemical reduction is carried out with hydrogen gas at a temperature of at least 300° C.

23. The method of claim 22 further comprising an annealing treatment in a controlled atmosphere at a temperature of at least 600° C.

24. The method of claim 23 wherein said controlled atmosphere is an inert atmosphere.
